(19) United States
(12) Patent Application Publication
(10) Pub. No.: US 2016/0355420 A1
(43) Pub. Date: Dec. 8, 2016

(54) MONITORING CONTROL DEVICE, WATER TREATMENT SYSTEM INCLUDING THE SAME, AND WATER TREATMENT METHOD

(71) Applicant: Hitachi, Ltd., Tokyo (JP)

(72) Inventors: Misaki SUMIKURA, Tokyo (JP); Hiroto YOKOI, Tokyo (JP); Takeyuki KONDOU, Tokyo (JP); Hiroki YAMAMOTO, Tokyo (JP)

(21) Appl. No.: 15/161,551

(22) Filed: May 23, 2016

(30) Foreign Application Priority Data
Jun. 5, 2015 (JP) 2015-114488

(51) Int. Cl. C02F 1/52; C02F 1/44; C02F 1/66

(52) U.S. Cl. CPC C02F 1/5209; C02F 1/66; C02F 1/442; C02F 2101/32

(57) ABSTRACT

A water treatment system includes a water treatment facility which has a coagulation treatment unit injecting a coagulant into water to be treated including oil components and performing coagulation treatment and a monitoring control device which has an oil water separating unit introducing a part of the supernatant water after the coagulation treatment by the coagulation treatment unit and separating the oil components and a deposition tank depositing soluble components dissolved in the supernatant water after separating the oil water. The monitoring control device has a control unit which controls an injection rate of the coagulant, on the basis of at least a deposition amount of the soluble components by the deposition tank.

### CLAIM OF PRIORITY

The present application claims priority from Japanese Patent application serial No. 2015-114488, filed on Jun. 5, 2015, the content of which is hereby incorporated by reference into this application.

### BACKGROUND OF THE INVENTION

1. Field of the Invention

The present invention relates to a water treatment system for enhanced oil recovery (EOR) and more particularly, to a monitoring control device capable of appropriately managing a concentration of sulfate ions of water to be treated, a water treatment system including the same, and a water treatment method.

2. Description of the Related Art

As a method of extracting crude oil from an oil layer, flush production using a pressure stored in bedrock is used conventionally. However, recently, various extraction methods are developed for the purpose of improving a recovery rate of the crude oil. These are called EOR and a water flooding or a chemical flooding exists as a representative example thereof. The water flooding is a method of pressing water into the oil layer to give oil scavenging energy artificially, maintaining productivity, and improving an ultimate recovery factor greatly. In addition, the chemical flooding to be an improvement of the water flooding is a general term of methods of pressing chemical drugs or a mixture thereof into the oil layer and improving the recovery factor of the crude oil. However, the chemical flooding is classified into a surfactant flooding, a polymer flooding, and a caustic flooding by the used drugs and principles of improvement of recovery factors thereof are different from each other. The surfactant flooding is a method of pressing a series of fluids including a solution using a surfactant as a main component into the oil layer to decrease interfacial tension between the crude oil and the water, extracting the crude oil captured by capillary action, and recovering the crude oil.

The management of the quality of the water used in these methods is an important element that is directly linked to an amount of production. For example, because suspended solids (SS) become a factor to close pores of oil rock or pipes becoming paths which the crude oil passes through, a particle diameter and a concentration are managed. In addition, because a basement is under a reduction atmosphere, a dissolved oxygen concentration is managed to maintain the reduction atmosphere and suppress deposition of an oxide. Also, sulfate ions that are combined with alkaline-earth metal elements such as Ba and Sr included in the underground and form a sulfate solid become one of management items. The sulfate ions are mainly mixed when seawater is desalted and is applied to EOR. As a method of removing the sulfate ions of the water, a nano-filtration (NF) film is introduced recently. Because the NF film has low pressure loss relating to membrane penetration as compared with an RO film to desalt NaCl, the NF film can manage the sulfate ions simply with relatively low energy. However, if a facility becomes a large-scale facility in which a supply amount of water used for EOR is several tens of thousands m³/d, an initial cost relating to an NF film treatment facility increases and a running cost of the NF film to be a consumable supply increases, which results in increasing an oil production cost. Therefore, an attempt to provide the pretreatment unit to remove soluble components generating a solid by deposition or a combination on a front step to perform desalination treatment using a film is made.

For example, WO2013/153587 discloses technology for recovering soluble silica by performing deposition and filtration by magnesium salt addition under an alkaline condition with respect to produced water including the soluble silica and sulfate ions and performing treatment by a reverse osmosis membrane. pH and Langelier's index of water supplied to the reverse osmosis membrane are adjusted, so that deposition of the soluble silica and soluble calcium remaining in the supply water on a surface of the reverse osmosis membrane is avoided, and fresh water can be recovered efficiently.

In addition, JP-2009-125708-A discloses technology for removing particulate components by coagulation treatment and removing soluble components by ozone acceleration oxidation treatment, which is an application example of the field of waste water treatment of electronic materials. Alkali addition and filtration processes are provided between the coagulation treatment and the ozone acceleration oxidation treatment, so that deposition of metal soluble components in an ozone acceleration oxidation treatment process is avoided, and the waste water treatment can be performed stably and efficiently.

### CITATION LIST

### Patent Document

[Patent Document 1] WO2013/153587
[Patent Document 2] JP-2009-125708-A

### SUMMARY OF THE INVENTION

However, when produced water from an oil well corresponding to raw water, seawater, or brackish water is used, deposits may be included in the soluble components included in the raw water, water to be treated, due to a change of conditions other than the alkaline condition, for example, a decrease in water temperature, an increase in dissolved oxygen concentration, or a time passage. When the technology described in WO2013/153587 or JP-2009-125708-A is applied to the water to be treated, the possibility of deposition of the soluble components in a treatment process of a rear step is high. The deposition of the soluble components in the treatment process of the rear step causes closing of a pipeline or a filtration device.

Accordingly, the present invention provides a monitoring control device capable of removing substances, which may be deposited in a treatment process of a rear step, surely in a coagulation treatment process and suppressing occurrence of deposit in a pipeline, a water treatment system including the same, and a water treatment method.

An aspect of the present invention provides a water treatment system including a water treatment facility which has a coagulation treatment unit injecting a coagulant into water to be treated including oil components and supplying supernatant water after coagulation treatment for a treatment process of a rear step and a monitoring control device which has an oil water separating unit introducing a part of the supernatant water after the coagulation treatment by the coagulation treatment unit and separating the oil components from the supernatant water and a deposition tank depositing soluble components dissolved in the supernatant water after separating the oil water, wherein the monitoring control device has a control unit which controls an injection rate of the coagulant, on the basis of at least a deposition amount of the soluble components by the deposition tank.

Another aspect of the present invention provides a monitoring control device including an oil water separating unit which introduces supernatant water after coagulation treatment with respect to water to be treated including oil components and separates the oil components from the supernatant water; a deposition tank which deposits soluble components dissolved in the supernatant water after separating the oil water; and a control unit which calculates an injection rate of a coagulant to be injected into the water to be treated, on the basis of at least a deposition amount of the soluble components by the deposition tank.

A further aspect of the present invention provides a water treatment method for injecting a coagulant into water to be treated including oil components and supplying supernatant water after coagulation treatment for a treatment process of a rear step, the water treatment method including introducing a part of the supernatant water after the coagulation treatment and separating the oil components from the supernatant water; depositing soluble components dissolved in the supernatant water after separating the oil water; and calculating an injection rate of the coagulant to be injected into the water to be treated including the oil components, on the basis of at least a deposition amount.

According to the present invention, it can be provided that a monitoring control device capable of removing substances, which may be deposited in a treatment process of a rear step, surely in a coagulation treatment process and suppressing occurrence of deposits in a pipeline, a water treatment system including the same, and a water treatment method.

Other objects and advantages of the invention will become apparent from the following description of embodiments with reference to the accompanying drawings.

### BRIEF DESCRIPTION OF THE DRAWINGS

FIG. 1 is an entire configuration diagram of a water treatment system according to an embodiment of the present invention;

FIG. 2 is a functional block diagram of a control unit in a monitoring control device illustrated in FIG. 1;

FIG. 3 is a control flow diagram by the control unit illustrated in FIG. 2;

FIG. 4 is a diagram illustrating a relation of water to be treated (raw water), coagulation/settlement treatment water, and inflow water in a treatment process of a rear step and a soluble component concentration, when this embodiment and a constant coagulant injection rate method are applied; and

FIG. 5 is a control flow diagram by a control unit in a monitoring control device configuring a water treatment system according to another embodiment of the present invention.

### DESCRIPTION OF THE PREFERRED EMBODIMENTS

In the present specification, an example of the case in which cooling treatment is used as a deposition acceleration method in a deposition tank in a monitoring control device configuring a water treatment system according to an embodiment of the present invention will be described. However, the deposition acceleration method is not limited to the cooling treatment and includes the following aspects.

For example, there are pH adjustment (high pH condition) by addition of an alkaline agent, water temperature adjustment by cooling/heating, concentration by heating/evaporation, supply (oxygen atmosphere) of dissolved oxygen (DO) by aeration, and deposition/coagulation reaction acceleration by slow stirring. An appropriate deposition acceleration method may be selected in consideration of a water quality of water to be treated to be raw water or a treatment process of a water treatment facility and may be used. For example, when a water temperature decreases from a coagulation/settlement/filtration treatment to a treatment of a rear step in a cold region, deposition by reduction of solubility of soluble components can be accelerated by cooling by a deposition tank. It is effective to accelerate deposition by an oxidation reaction by aeration in a water treatment facility including a coagulation process after the coagulation treatment. In addition, a combination of the plurality of deposition acceleration methods may be applied.

Preferred embodiments of the present invention will be described in detail below with reference to the accompanying drawings, wherein like reference numerals refer to like parts throughout.

### First Embodiment

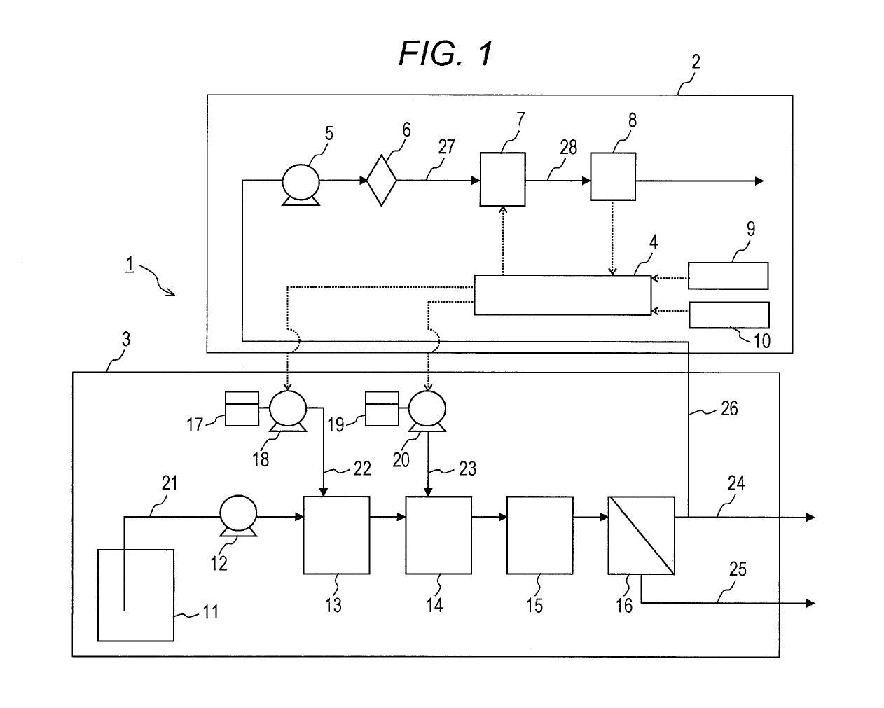

FIG. 1 is an entire configuration diagram of a water treatment system according to an embodiment of the present invention. A water treatment system 1 includes a monitoring control device 2 and a water treatment facility 3. Hereinafter, an example of the case in which cooling treatment is applied as a deposition acceleration method and one kind of coagulant is used will be described. The water treatment facility 3 includes a raw water tank 11 to store water to be treated from the upstream side to the downstream side thereof along a flow of raw water of a treatment object, that is, the water to be treated including oil components, a pH adjusting tank 13, a coagulation tank 14, a flock forming tank 15, and a flock recovering tank 16.

The raw water tank 11 and the pH adjusting tank 13 are connected by a water intake pipeline 21 and a water intake pump 12 is attached to the water intake pipeline 21. In addition, the pH adjusting tank 13 is connected to a pH adjuster tank 17 storing a pH adjuster, such that a predetermined amount of pH adjuster can be injected into the pH adjusting tank 13 via a pH adjuster introduction pipeline 22. A pH adjuster pump 18 is attached to the pH adjuster introduction pipeline 22. By the pH adjuster pump 18, the predetermined amount of pH adjuster is injected into the pH adjusting tank 13 from the pH adjuster tank 17. In addition, the pH adjusting tank 13 is connected to the coagulation tank 14 disposed on a rear step thereof via the pipeline.

The coagulation tank 14 is connected to a coagulant tank 19 storing a coagulation agent, such that a predetermined amount of flocculation agent can be injected via a coagulant introduction pipeline 23. A coagulant pump 20 is attached to the coagulant introduction pipeline 23. By the coagulant pump 20, the predetermined amount of coagulant is injected into the coagulation tank 14 from the coagulant tank 19. The coagulation tank 14 is connected to the flock forming tank 15 disposed on a rear step thereof via the pipeline and the flock forming tank 15 is connected to the flock recovering tank 16 disposed on a rear step thereof via the pipeline. An injection pipeline 24 to inject supernatant water into an oil layer and a concentrated water drainage pipeline 25 to supply concentrated water after coagulated flock recovery for a sludge treatment process of a rear step are provided in the flock recovering tank 16. In addition, a branching pipeline 26 to supply a part of the supernatant water obtained from the flock recovering tank 16 to the monitoring control device 2 is connected to the injection pipeline 24. In the present specification, a coagulation treatment unit is configured by including the coagulation tank 14, the flock forming tank 15, the flock recovering tank 16, the coagulant tank 19, the coagulant pump 20, and the coagulant introduction pipeline 23. In addition, a unit including the pH adjusting tank 13, the pH adjuster tank 17, the pH adjuster pump 18, and the pH adjuster introduction pipeline 22 disposed at the front step (upstream) side of the coagulation tank 14 may be called the coagulation treatment unit.

The monitoring control device 2 includes a water intake pump 5, an oil water separating unit 6, a deposition tank 7, and an SS measuring unit 8 attached to the branching pipeline 26, from the upstream side to the downstream side thereof along a flow of the supernatant water circulating through the branching pipeline 26. Further, the monitoring control device 2 includes a control unit 4 that controls the deposition tank 7 and the pH adjuster pump 17 and the coagulant pump 20 configuring the water treatment facility 3 and inputs a measurement value from the SS measuring unit 8. In addition, the input unit 9 and the display unit 10 to be an output unit are electrically connected to the control unit 4.

The branching pipeline 26 branching off from the injection pipeline 24 is connected to the oil water separating unit 6. By the water intake pump 5, the supernatant water circulating through the branching pipeline 26 flows into the oil water separating unit 6. The oil water separating unit 6 is connected to the deposition tank 7 via a deposition tank inflow pipeline 27. The deposition tank 7 is connected to the SS measuring unit 8 via a deposition tank outflow pipeline 28. In addition, a stirrer not illustrated in the drawings is disposed in each of the pH adjusting tank 13, the coagulation tank 14, and the flock forming tank 15. Here, the stirrer has a stirring blade and a rotation shaft to supply drive force by a drive device such as a motor connected to the stirring blade to the stirring blade. However, the stirrer is not limited to the above configuration and an ultrasonic stirrer or like may be appropriately used. Hereinafter, an example of the stirrer including the stirring blade and the drive device will be described.

Next, an operation of the water treatment system 1 will be described. The water intake pump 12 supplies the raw water, water to be treated including the oil components, to the pH adjusting tank 13 via the water intake pipeline 21. In the pH adjusting tank 13, a predetermined amount of pH adjuster stored in the pH adjuster tank 17 is injected into the raw water to be the treatment object water including the oil components via the pH adjuster pump 18 and the pH adjuster introduction pipeline 22. As a treatment result, pH of the water to be treated (raw water) including the oil components is changed by adding the pH adjuster to the water to be treated including the oil components. The water to be treated (raw water) flown out from the pH adjusting tank 13 and including the oil components flows into the coagulation tank 14 disposed on a rear step. By the flocculation agent pump 20, the predetermined amount of coagulant is injected into the coagulation tank 14 via the coagulant introduction pipeline 23 from the coagulant tank 19. As a treatment result, soluble components or suspended solids (SS) of the water to be treated (raw water) including the oil components are captured by the coagulant and a coagulated flock is formed. The water to be treated (raw water) flown out from the coagulation tank 14 and including the oil components flows into the flock forming tank 15 and the coagulated flock is grown. Here, an inorganic coagulant such as ferric chloride or an organic coagulant such as alginate sodium is used as the coagulant. However, ferric chloride is preferably used.

Then, the water to be treated (raw water) including the oil components flows into the flock recovering tank 16 from the flock forming tank 15 and is separated into the supernatant water and the concentrated water of the coagulated flock. The supernatant water is supplied for a treatment process of a rear step via the injection pipeline 24. Here, the treatment process of the rear step is a process for injecting the supernatant water to the oil layer not illustrated in the drawings. In addition, the concentrated water of the coagulated flock flows for a sludge treatment process of a rear step not illustrated in the drawings via the concentrated water drainage pipeline 25.

The water intake pump 5 supplies the supernatant water to the oil water separating unit 6 via the branching pipeline 26. The oil components and the particulate substances are removed from the supernatant water by the oil water separating unit 6 and the supernatant water flows into the deposition tank 7 via the deposition tank inflow pipeline 27. After the supernatant water is cooled by the deposition tank 7, the supernatant water flows into the SS measuring unit 8 via the deposition tank outflow pipeline 28. Here, an SS concentration meter of an infrared transmission method or an SS concentration meter of a scattering light method is used as the SS measuring unit 8. In this embodiment, the SS concentration meter is used. However, instead of the SS concentration meter, a turbidity meter of the scattering light method may be used.

When the supernatant water is cooled by the deposition tank 7 and soluble components such as calcium and magnesium of the supernatant water have a concentration equal to or more than solubility at a water temperature after cooling, hydroxides are deposited by the deposition tank 7 and are detected as an SS concentration (unit: mg/L) in the SS measuring unit 8. An SS concentration measurement value at that time is transmitted to the control unit 4.

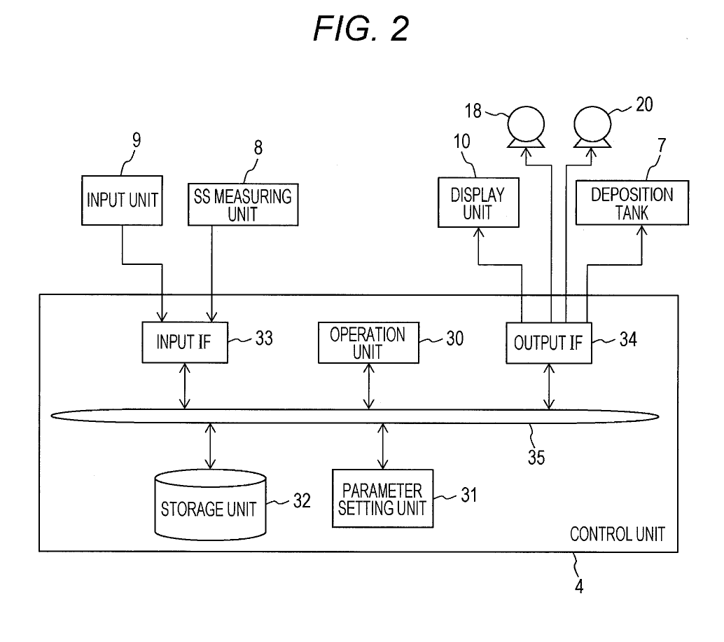

Here, a configuration of the control unit 4 will be described. FIG. 2 is a functional block diagram of the control unit 4 in the monitoring control device 2 illustrated in FIG. 1.

The control unit 4 includes an operation unit 30 to execute a control operation to be described below, a parameter setting unit 31, a storage unit 32, an input IF 33, an output IF 34, and an internal bus 35. The input IF 33 acquires various parameters input by an operator via the input unit 9 and the SS concentration measurement value measured by the SS measuring unit 8. The acquired various parameters are input to the operation unit 30 and the parameter setting unit 31 via the internal bus 35 and the parameter setting unit 31 stores the input various parameters in the storage unit 32 via the internal bus 35. In addition, the acquired SS concentration measurement value is input to the operation unit 30 via the internal bus 35. The operation unit 30 executes an operation to be described in detail below, on the basis of the input various parameters and the SS concentration measurement value. An operation result by the operation unit 30 is output as a control command to the pH adjuster pump 18, the coagulant pump 20, and the deposition tank 7 via the internal bus 35 and the output IF 34. In addition, when warning information is output on the basis of the operation result by the operation unit 30, the warning information is output as an alarm signal to the display unit 10 via the output IF 34.

Here, the operation unit 30 is implemented by other storage unit (not illustrated in the drawings) such as a ROM storing various programs to execute the control operation and a RAM temporarily storing an operation result or a result in the course of the operation and a processor such as a CPU reading the various programs stored in the ROM and executing the various programs. In some cases, the various programs and the operation result or the result in the course of the operation may be stored in the storage unit 32, instead of the ROM and the RAM, in a state in which the various parameters and storage areas are divided.

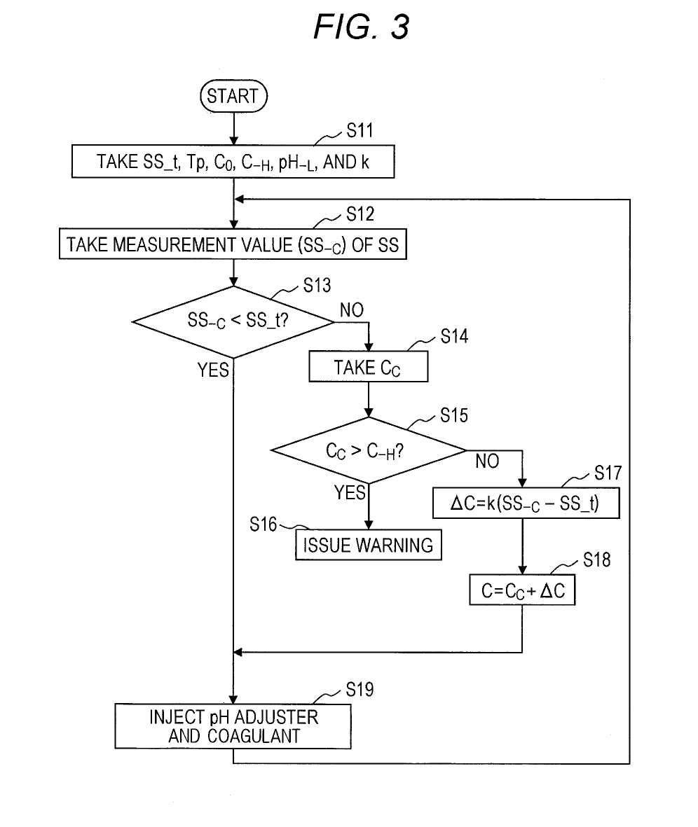

FIG. 3 is a control flow diagram by the control unit 4 illustrated in FIG. 2. In this embodiment, the control unit 4 controls the pH adjuster pump 18 and the coagulant pump 20, such that the SS concentration measurement value measured by the SS measuring unit 8 becomes equal to or less than a target value.

As illustrated in FIG. 3, first, the operation unit 30 reads and acquires a target value SS_t of the SS measurement value, a water temperature setting value Tp in the deposition tank 7, an initial injection rate C₀ of the coagulant, an upper limit C_{—H} of a coagulant injection rate C, a pH lower limit target value pH_{—L} of the coagulation tank 14, and a proportional coefficient k to be the various parameters input by the operator via the input unit 9 and stored in the storage unit 32, from the storage unit 32 via the internal bus 35 (step S11). The operation unit 30 transmits the water temperature setting value Tp acquired in step S11 as a control command to the deposition tank 7 via the output IF 34 and the deposition tank 7 executes control such that the water temperature becomes Tp. Next, the operation unit 30 acquires the SS measurement value, that is, a current SS measurement value SS_{—C} from the SS measuring unit 8 via the input IF 33 (step S12). In step S13, the operation unit 30 compares the current SS measurement value SS_{—C} and the target value SS_t of the SS measurement value and determines whether the current SS measurement value SS_{—C} is less than the target value SS_t of the SS measurement value.

As a determination result in step S13, when the current SS measurement value SS_{—C} is equal to or more than the target value SS_t of the SS measurement value, the operation unit 30 acquires a current coagulant injection rate C_{C} (step S14). In step S15, the operation unit 30 compares the current coagulant injection rate C_{C} and the upper limit C_{—H} of the coagulant injection rate C and determines whether the current coagulant injection rate C_{C} is more than the upper limit C_{—H} of the coagulant injection rate C. As a determination result, when the current coagulant injection rate C_{C} is more than the upper limit C_{—H} of the coagulant injection rate C, the operation unit 30 transmits a signal showing a warning of a coagulant injection rate upper limit, that is, warning information to the display unit 10 via the internal bus 35 and the output IF 34 (step S16).

As the determination result in step S15, when the current coagulant injection rate C_{C} is equal to or less than the upper limit C_{—H} of the coagulant injection rate C, the operation unit 30 calculates an increasing amount ΔC of the coagulant injection rate C from the following expression (1) previously stored in the storage unit 32 (step S17).

ΔC=k·(SS_{—C}−SS_t) [Expression 1]

Next, in step S18, the operation unit 30 increases the coagulant injection rate C by the coagulant pump 20 from the current coagulant injection rate C_{C} by ΔC (step S18) and the process proceeds to step S19.

In step S19, the operation unit 30 transmits a control command (discharge flow rate of the pump) to the pH adjuster pump 18 via the output IF 34, such that a measurement value of a pH meter (not illustrated in FIG. 1) attached to the coagulation tank 14, that is, a current pH measurement value pH_{C} in the coagulation tank 14 becomes the pH lower limit target value pH_{—L} approximately, and executes running control of the pH adjuster pump 18. In addition, the operation unit 30 transmits a control command (discharge flow rate of the pump) to the coagulant pump 20 via the output IF 34, such that the coagulant injection rate C calculated in step S18 is obtained, and executes running control of the coagulant pump 20. Then, the process returns to step S12.

In step S13, when the current SS measurement value SS_{—C} is less than the target value SS_t of the SS measurement value, the process proceeds to step S19. The operation unit 30 transmits a control command (discharge flow rate of the pump) to the pH adjuster pump 18 via the output IF 34, such that the measurement value of the pH meter (not illustrated in FIG. 1) attached to the coagulation tank 14, that is, the current pH measurement value pH_{C} in the coagulation tank 14 becomes the pH lower limit target value pH_{—L} approximately, and executes the running control of the pH adjuster pump 18. At this time, the operation unit 30 transmits a control command (discharge flow rate of the pump) to the coagulant pump 20 via the output IF 34, such that the current coagulant injection rate C_{C} is maintained, and executes the running control of the coagulant pump 20. Then, the process returns to step S12.

In the case in which soluble components beyond a range in which soluble components can be removed by the coagulation treatment in the coagulation tank 14 are included in the raw water, water to be treated including the oil components, even if the coagulant injection rate C is increased, the current SS measurement value SS_{—C} measured by the SS measuring unit 8 may not decrease. Or, an injection position of the coagulant may be out of an optimal injection region of the coagulant. In this case, in this embodiment, because a signal showing a warning of the coagulant injection rate upper limit, that is, warning information is output to the display unit 10 in step S16, the operator can quickly take measures such as changing the coagulant injection rate by a jar tester and adding other treatment process before and after the coagulation treatment. In this embodiment, the warning information is displayed on the display unit 10. However, the present invention is not limited thereto. For example, a speaker may be provided as a sound output unit and a warning sound such as a beep sound may be generated.

Among the various parameters acquired in step S11, the target value SS_t of the SS measurement value is preferably set to the measurement lower limit of the SS measuring unit 8. In addition, the initial injection rate C₀ of the coagulant may be set on the basis of a result of a jar test and the proportional coefficient k may be set on the basis of a response characteristic of a treatment process.

The water temperature setting value Tp of the deposition tank 7 that is stored in the storage unit 32 via the input unit 9 and the parameter setting unit 31 can be previously calculated in the following sequence. The water temperature setting value Tp of the deposition tank 7 is preferably set in a condition where an SS deposition amount at the water temperature Tp becomes equal to a deposition amount of soluble components of the raw water, the water to be treated, after the coagulation treatment, that is, the supernatant water reaching from the flock recovering tank 16 to the oil layer via the injection pipeline 24. Therefore, a time of flow assumed as a time needed until a filtrate obtained by filtering the raw water to be the actual water to treated including the oil components by a filter having an aperture of about 1 μm or less reaches the oil layer after injecting the filtrate into a beaker and performing the coagulation treatment on the filtrate in an actual plant (water treatment facility) and an SS concentration (SS_p) after the filtrate is stirred under a condition of the water temperature are measured.

Next, the same filtrate is injected into the beaker and is cooled while being stirred and a casual water temperature and an SS concentration are measured. From a measurement result, a relational expression of a water temperature (T) and an SS concentration (SS′: prediction value of a deposition amount) such as the following expression (2) is made.

SS′=a·T−b [Expression 2]

Here, a and b are coefficients. The water temperature (T) when SS′ becomes SS_p, calculated from the relational expression, may be set to Tp. When SS_p is measured, an actual condition is preferably simulated maximally. However, it is difficult to simulate the actual condition completely. For this reason, a setting valve of Tp may be set to a value lower than a calculated value, including a safety factor of several ten %.

In addition, a value obtained by reducing a constant value, for example, 10° C. from the water temperature of the water to be treated including the oil components to be the water temperature higher than a freezing point of the water to be treated (raw water) including the oil components may be set to Tp.

When a method other than the cooling is used as the deposition acceleration method, the deposition tank 7 may be run under the condition where SS_p is obtained. For example, when the pH adjustment (high pH condition) by addition of the alkaline agent is used, the same filtrate is injected into the beaker, the alkaline agent is added to the filtrate while the filtrate is stirred, and casual pH and an SS concentration are measured. From a measurement result, a relational expression of a pH value (pH) and an SS concentration (SS′: prediction value of a deposition amount) such as the following expression (3) is made.

SS′=c·Ln(pH)+d [Expression 3]

Here, c and d are coefficients. A pH value when the prediction value SS′ of the deposition amount becomes SS_p, calculated from the relational expression, may be set to pH_p. Likewise, when the concentration by the heating/evaporation is used, a relational expression of a concentration rate and an SS concentration may be calculated by an experiment, when the supply of the dissolved oxygen (DO) by the aeration is used, a relational expression of a dissolved oxygen concentration (DO concentration) and an SS concentration may be calculated by an experiment, and the deposition tank 7 may be run under a condition where the prediction value SS′ of the deposition amount becomes SS_p. The expression (3), the relational expression of the concentration rate and the SS concentration, or the relational expression of the dissolved oxygen concentration (DO concentration) and the SS concentration may be may be previously stored in the storage unit 32 and may be read by the operation unit 30.

As the soluble components included in the produced water, the seawater, or the brackish water, which may be deposited by the treatment process of the rear step, there are calcium, magnesium, strontium, sulfate ions, silica, and iron. As the coagulant, a coagulant having performance to remove the soluble components to a concentration allowable in the treatment process of the rear step may be appropriately selected.

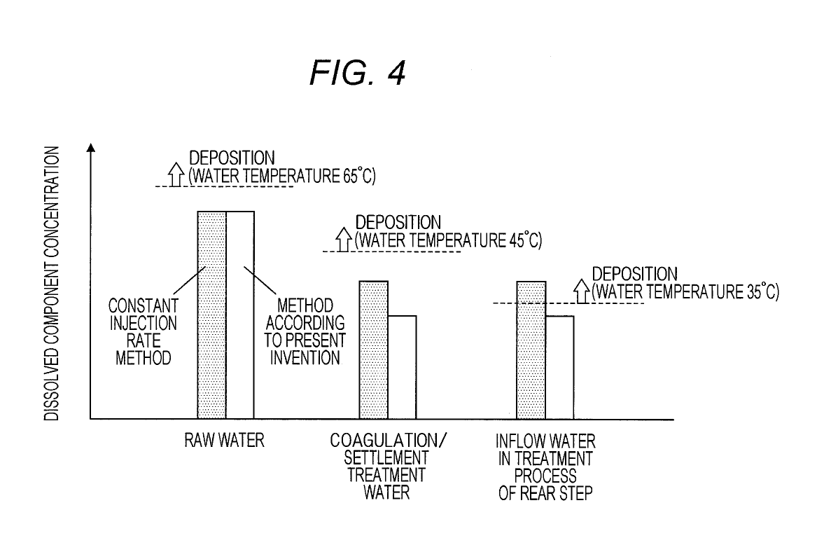

FIG. 4 illustrates a relation of water to be treated (raw water), water to be treated (coagulation/settlement treatment water) after coagulation treatment, and inflow water in a treatment process of a rear step and a soluble component concentration, when this embodiment and a constant coagulant injection rate method according to a comparative example are applied.

In the water to be treated (raw water) such as the produced water, multiple kinds of substances are generally melted at a temperature higher than an external temperature. In an example illustrated in FIG. 4, a temperature of the raw water is 65° C. During the coagulation/settlement/filtration treatment process, the water temperature gradually decreases to 45° C. Accordingly, a soluble component concentration decreases. In addition, a deposition limit concentration shown by a dotted line in FIG. 4 also decreases. However, deposits are removed by the coagulation/settlement and a soluble component concentration of the water to be treated (coagulation/settlement treatment water) after the coagulation treatment is less than the deposition limit concentration. However, in the treatment process of the rear step, if the water temperature decreases to 35° C., in the case of applying the constant coagulant injection rate method according to the comparative example, the soluble component concentration may be more than the deposition limit concentration, as illustrated in FIG. 4.

Meanwhile, in this embodiment, even in the treatment process of the rear step, the soluble component concentration less than the deposition limit concentration can be maintained. This is because, as described above, in this embodiment, the injection rate C of the coagulant injected into the coagulation tank 14 configuring the water treatment facility 3 is increased by ΔC, on the basis of the result (the measurement value of the SS concentration: the deposition amount of the soluble components) of the deposition acceleration treatment obtained by simulating the reduction of the deposition limit concentration in the deposition tank 7 configuring the monitoring control device 2. As a result, the soluble component concentration of the inflow water in the treatment process of the rear step after the coagulation treatment can be reduced and the deposition amount of the soluble components can be reduced or the deposition can be avoided.

According to this embodiment, in the coagulation treatment process, the substances, which may be deposited in the treatment process of the rear step, can be surely removed and occurrence of the deposits in the pipeline can be suppressed.

In addition, according to this embodiment, even when the water quality of the water to be treated (raw water) changes, the injection rate of the coagulant is controlled on the basis of the result of the deposition acceleration treatment for the small amount of water to be treated (supernatant water) after the coagulation treatment, so that deposition of the soluble components in the oil layer of the rear step can be suppressed.

As such, the coagulation treatment is controlled to correspond to the change of the water quality of the water to be treated (raw water), so that the entire water treatment facility can be stably run. In addition, closing of pores in the oil layer is suppressed, so that crude oil can be produced efficiently and a running cost can be reduced.

### Second Embodiment

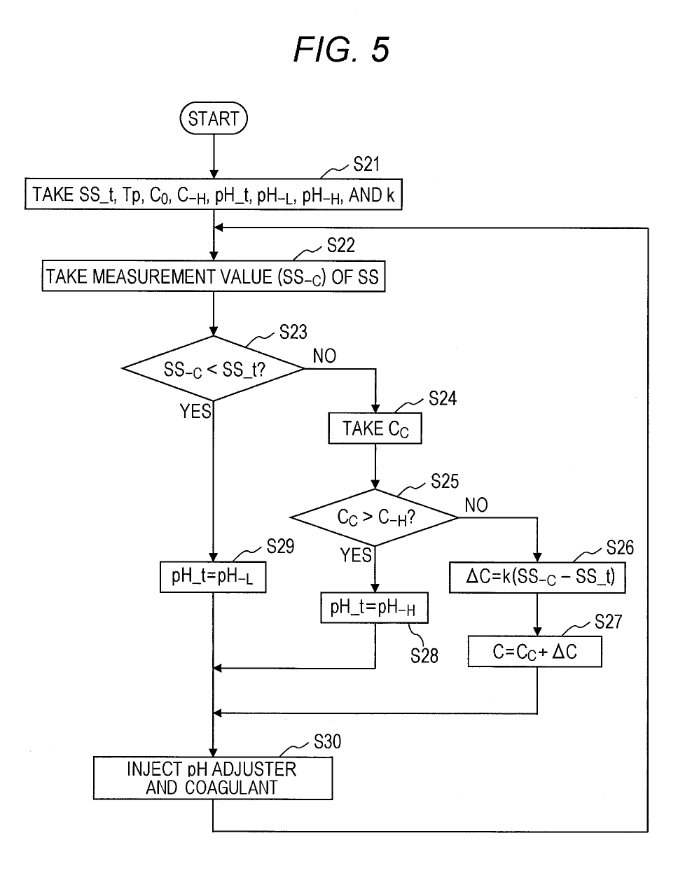

FIG. 5 is a control flow diagram by a control unit in a monitoring control device configuring a water treatment system according to another embodiment of the present invention. This embodiment is different from the first embodiment in that pH adjustment in a coagulation tank 14 is performed, in addition to controlling an injection rate of a coagulant injected into the coagulation tank 14, on the basis of a result of a deposition acceleration treatment by a deposition tank 7.

Specifically, even when a current coagulant injection rate C_{C} of the coagulation tank 14 is more than an upper limit C_{—H} of a coagulant injection rate, deposition of soluble components is accelerated by setting a condition where pH of a pH adjusting tank 13 disposed on a front step of the coagulation tank 14 is high, before a coagulated flock is formed, and a removal rate of the soluble components can be improved as compared with the first embodiment. Because an entire configuration of a water treatment system 1 and configurations of a monitoring control device 2 and a water treatment facility 3 are the same as those in the first embodiment, description overlapped to the description of the first embodiment is omitted hereinafter. In this embodiment, an example of the case in which a coagulant of which an applicable pH region is wide as about pH 5 to pH 10 is used will be described hereinafter.

In this embodiment, a control unit 4 configuring the monitoring control device 2 controls a pH adjuster pump 18 and a coagulant pump 20, such that a prediction value (SS′) of a deposition amount in which soluble components included in supernatant water, calculated using an SS concentration measurement value, a water temperature measurement value, and a pH measurement value, are deposited in a treatment process of a rear step becomes equal to or less than a target value.

As illustrated in FIG. 5, first, an operation unit 30 reads and acquires a target value SS_t of an SS measurement value, a water temperature setting value Tp in the deposition tank 7, an initial injection rate C₀ of the coagulant, an upper limit C_{—H} of a coagulant injection rate C, a target value pH_t of a measurement value by a pH meter (not illustrated in the drawings) attached to the coagulation tank 14, a pH lower limit target value pH_{—L} of the coagulation tank 14, a pH upper limit target value pH_{—H} of the coagulation tank 14, and a proportional coefficient k to be various parameters input by an operator via an input unit 9 (refer to FIG. 3) and stored in a storage unit 32, from a storage unit 32 via an internal bus 35 (step S21). The operation unit 30 transmits the water temperature setting value Tp acquired in step S21 as a control command to the deposition tank 7 via an output IF 34 and the deposition tank 7 executes control such that the water temperature becomes Tp. Next, the operation unit 30 acquires the SS measurement value, that is, a current SS measurement value SS_{—C} from an SS measuring unit 8 via an input IF 33 (step S22). In step S23, the operation unit 30 compares the current SS measurement value SS_{—C} and the target value SS_t of the SS measurement value and determines whether the current SS measurement value SS_{—C} is less than the target value SS_t of the SS measurement value.

As a determination result in step S23, when the current SS measurement value SS_{—C} is equal to or more than the target value SS_t of the SS measurement value, the operation unit 30 acquires a current coagulant injection rate C_{C} (step S24). In step S25, the operation unit 30 compares the current coagulant injection rate C_{C} and the upper limit C_{—H} of the coagulant injection rate and determines whether the current coagulant injection rate C_{C} is more than the upper limit C_{—H} of the coagulant injection rate. As a determination result, when the current coagulant injection rate C_{C} is equal to or less than the upper limit C_{—H} of the coagulant injection rate, the process proceeds to step S26. In step S26, the operation unit 30 calculates an increasing amount ΔC of the coagulant injection rate C from the following expression (1) previously stored in the storage unit 32.

ΔC=k·(SS_{—C}−SS_t) [Expression 1]

Next, in step S27, the operation unit 30 increases the coagulant injection rate C by the coagulant pump 20 from the current coagulant injection rate C_{C} by ΔC and the process proceeds to step S30.

In step S30, the operation unit 30 transmits a control command (discharge flow rate of the pump) to the pH adjuster pump 18 via the output IF 34, such that the measurement value of the pH meter (not illustrated in FIG. 1) attached to the coagulation tank 14, that is, a current pH measurement value pH_{C} in the coagulation tank 14 becomes the target value pH_t of the measurement value by the pH meter, and executes running control of the pH adjuster pump 18. In addition, the operation unit 30 transmits a control command (discharge flow rate of the pump) to the coagulant pump 20 via the output IF 34, such that the coagulant injection rate C calculated in step S27 is obtained, and executes running control of the coagulant pump 20. Then, the process returns to step S22.

Meanwhile, as the determination result in step S25, when the current coagulant injection rate C_{C} is more than the upper limit C_{—H} of the coagulant injection rate, the operation unit 30 sets the target value pH_t of the pH meter attached to the coagulation tank 14 to the pH upper limit target value pH_{—H} of the coagulation tank 14 (step S28) and the process proceeds to step S30. In step S30, the operation unit 30 transmits a control command (discharge flow rate of the pump) to the pH adjuster pump 18 via the output IF 34, such that the current pH measurement value pHc in the coagulation tank 14 becomes the pH upper limit target value pH_{—H} approximately, and executes the running control of the pH adjuster pump 18. At this time, the current coagulant injection rate C_{C} is maintained as the coagulant injection rate C. Then, the process returns to step S22.

As the determination result in step S23, when the current SS measurement value SS_{—C} is less than the target value SS_t of the SS measurement value, the process proceeds to step S29. In step S29, the operation unit 30 sets the target value pH_t of the pH meter attached to the coagulation tank 14 to the pH lower limit target value pH_{—L} of the coagulation tank 14 (step S28) and the process proceeds to step S30. In step S30, the operation unit 30 transmits a control command (discharge flow rate of the pump) to the pH adjuster pump 18 via the output IF 34, such that the current pH measurement value pHc in the coagulation tank 14 becomes the pH lower limit target value pH_{—L} approximately, and executes the running control of the pH adjuster pump 18. At this time, the current coagulant injection rate C_{C} is maintained as the coagulant injection rate C. Then, the process returns to step S22.

Here, the initial injection rate C₀ of the coagulant, the upper limit C_{—H} of the coagulant injection rate, the pH upper limit target value pH_{—H} of the coagulation tank 14, and the pH lower limit target value pH_{—L} of the coagulation tank 14 may be preferably set on the basis of a result of a jar test, a water quality of the raw water, water to be treated of the applied water treatment facility 3, performance of the water treatment facility 3, and an available pH range of the coagulant. As the coagulant, ferric chloride can be used.

In step S28, when the target value pH_t of the pH meter attached to the coagulation tank 14 is set to the pH upper limit target value pH_{—H} of the coagulation tank 14, pH of the supernatant water may be more than a standard water quality or a target water quality. In this case, pH of the supernatant water may be decreased to be included in a range of the standard water quality by adding an acid agent to an injection pipeline 24 to be a flow channel of the supernatant water.

In this embodiment, the coagulant that can be used under an alkaline condition where pH is 10 or more is used, a condition where pH of the pH adjusting tank 13 is close to a lower limit of an available pH region of the coagulant is normally set, and running is performed. As a result, a consumption amount of an alkaline agent for pH adjustment can be reduced. Meanwhile, even in the case in which the coagulant injection rate C is set to the upper limit C_{—H} of the coagulant injection rate due to the change of the water quality of the raw water, water to be treated, when the prediction value SS′ of the deposition amount becomes equal to or more than the upper limit of the deposition amount, deposition of soluble components is accelerated by setting a condition where pH of the pH adjusting tank 13 is high (above-mentioned step S28), and a removal rate of the soluble components in the coagulation treatment can be increased.

According to this embodiment, in addition to the effect according to the first embodiment, even when the coagulant injection rate is more than the upper limit due to the change of the water quality of the water to be treated, pH of the coagulation tank is adjusted high, so that the removal rate of the soluble components in the water to be treated can be further improved.

In the above-mentioned first and second embodiments, the coagulation tank 14 and the flock forming tank 15 are provided, the water to be treated (raw water) including the oil components is circulated continuously, and the coagulation treatment is performed. However, the present invention is not limited thereto. For example, a configuration in which a flock is formed and grown by the coagulation tank 14, that is, a configuration in which the coagulation tank 14 functions as the flock forming tank 15 may be used. In this case, it is preferable to accelerate growth of the flock by performing slow stirring by a stirrer provided in the coagulation tank 14 and not illustrated in the drawings or performing fast stirring for a predetermined time and performing the slow stirring.

The present invention is not limited to the embodiments described above and various modifications are included in the present invention. For example, the embodiments are described in detail to facilitate the description of the present invention and the present invention is not limited to embodiments in which all of the described configurations are included. In addition, a part of the configurations of the certain embodiment can be replaced by the configurations of other embodiments or the configurations of other embodiments can be added to the configurations of the certain embodiment. In addition, for a part of the configurations of the individual embodiments, addition, removal, and replacement of the configurations of other embodiments can be performed.

### REFERENCE SIGNS LIST

1 . . . Water treatment system
2 . . . Monitoring control device
3 . . . Water treatment facility
4 . . . Control unit
5 . . . Water intake pump
6 . . . Oil water separating unit
7 . . . Deposition tank
8 . . . SS measuring unit
9 . . . Input unit
10 . . . Display unit
11 . . . Raw water tank
12 . . . Water intake pump
13 . . . pH adjusting tank
14 . . . Coagulation tank
15 . . . Flock forming tank
16 . . . Flock recovering tank
17 . . . pH adjuster tank
18 . . . pH adjuster pump
19 . . . Coagulant tank
20 . . . coagulant pump
21 . . . Water intake pipeline
22 . . . pH adjuster introduction pipeline
23 . . . Coagulant introduction pipeline
24 . . . Injection pipeline
25 . . . Concentrated water drainage pipeline
26 . . . Branching pipeline
27 . . . Deposition tank inflow pipeline
28 . . . Deposition tank outflow pipeline
30 . . . Operation unit
31 . . . Parameter setting unit
32 . . . Storage unit
33 . . . Input IF
34 . . . Output IF
35 . . . Internal bus

What is claimed is:

1. A water treatment system comprising:
a water treatment facility which has a coagulation treatment unit injecting a coagulant into water to be treated including oil components and supplying supernatant water after coagulation treatment for a treatment process of a rear step; and
a monitoring control device which has an oil water separating unit introducing a part of the supernatant water after the coagulation treatment by the coagulation treatment unit and separating the oil components from the supernatant water and a deposition tank precipitating soluble components dissolved in the supernatant water after separating the oil water, wherein
the monitoring control device has a control unit which controls an injection rate of the coagulant, on the basis of at least a deposition amount of the soluble components by the deposition tank.

2. The water treatment system according to claim 1, wherein
the monitoring control device includes a storage unit which stores at least a previously set deposition amount target value of the soluble components of the supernatant water and a measuring unit which measures the deposition amount of the soluble components by the deposition tank; and
the control unit calculates the injection rate of the coagulant, on the basis of the deposition amount target value and a measurement value of the deposition amount by the measuring unit.

3. The water treatment system according to claim 2, wherein
the coagulation treatment unit includes a flocculation tank which stirs the water to be treated including the oil components and the coagulant and a coagulant pump which injects a predetermined amount of coagulant into the coagulation tank from a coagulant tank;
the storage unit previously stores a correlation relation of a difference of the deposition amount target value and the measurement value of the deposition amount and an increasing amount of the coagulant injection rate; and
the control unit calculates the injection rate of the coagulant by a current value of the coagulant injection rate of the coagulation tank and the increasing amount of the coagulant injection rate obtained by the correlation relation and controls the coagulant pump such that the calculated injection rate is obtained.

4. The water treatment system according to claim 3, wherein
the coagulation treatment unit includes a pH adjusting tank which is disposed on a front step of the coagulation tank and adjusts pH of the water to treated including the oil components and a pH adjuster pump which injects a predetermined amount of pH adjuster into the pH adjusting tank from a pH adjuster tank; and
the control unit controls the pH adjuster pump, on the basis of the deposition amount target value and the measurement value of the deposition amount.

5. The water treatment system according to claim 4, wherein
the storage unit previously stores a pH lower limit target value in the coagulation tank; and
the control unit controls the pH adjuster pump, such that a pH value in the coagulation tank becomes the pH lower limit target value, when the measurement value of the deposition amount is less than the deposition amount target value.

6. The water treatment system according to claim 5, wherein
the storage unit previously stores an upper limit of the coagulant; and
the control unit outputs warning information, when the measurement value of the deposition amount is equal to or more than the deposition amount target value and a current value of the coagulant injection rate of the coagulation tank is more than the upper limit of the coagulant.

7. The water treatment system according to claim 5, wherein
the storage unit previously stores an upper limit of the coagulant and a pH upper limit target value of the coagulation tank; and
the control unit controls the pH adjuster pump, such that the pH value in the coagulation tank becomes the pH upper limit target value, when the measurement value of the deposition amount is equal to or more than the deposition amount target value and a current value of the coagulant injection rate of the coagulation tank is more than the upper limit of the coagulant.

8. The water treatment system according to claim 6, wherein
the storage unit previously stores a correlation relation of a water temperature of the supernatant water after separating the oil water in the deposition tank and a deposition amount of the soluble components dissolved in the supernatant water; and
the control unit controls the water temperature of the supernatant water in the deposition tank, on the basis of the correlation relation of the water temperature and the deposition amount.

9. The water treatment system according to claim 7, wherein
the storage unit previously stores a correlation relation of a water temperature of the supernatant water after separating the oil water in the deposition tank and a deposition amount of the soluble components dissolved in the supernatant water; and
the control unit controls the water temperature of the supernatant water in the deposition tank, on the basis of the correlation relation of the water temperature and the deposition amount.

10. A monitoring control device comprising:
an oil water separating unit which introduces supernatant water after coagulation treatment with respect to water to be treated including oil components and separates the oil components from the supernatant water;
a deposition tank which deposits soluble components dissolved in the supernatant water after separating the oil water; and
a control unit which calculates an injection rate of a coagulant to be injected into the water to be treated, on the basis of at least a deposition amount of the soluble components by the deposition tank.

11. The monitoring control device according to claim 10, further comprising:
a storage unit which stores at least a previously set deposition amount target value of the soluble components of the supernatant water; and
a measuring unit which measures the deposition amount of the soluble components by the deposition tank, wherein
the control unit calculates the injection rate of the coagulant, on the basis of the deposition amount target value and the measurement value of the deposition amount by the measuring unit.

12. The monitoring control device according to claim 11, wherein
the storage unit previously stores a correlation relation of a difference of the deposition amount target value and the measurement value of the deposition amount and an increasing amount of the injection rate of the coagulant injected in the coagulation treatment; and
the control unit calculates the injection rate of the coagulant to be injected into the water to be treated, by a current value of the injection rate of the coagulant in the coagulation treatment and the increasing amount of the coagulant injection rate obtained by the correlation relation.

13. The monitoring control device according to claim 12, wherein
the storage unit previously stores a pH lower limit target value of the water to be treated in the coagulation treatment; and
the control unit sets the pH lower limit target value as a pH value of the water to be treated in the coagulation treatment, when the measurement value of the deposition amount is less than the deposition amount target value.

14. The monitoring control device according to claim 13, further comprising:
a display unit, wherein
the storage unit previously stores an upper limit of the coagulant; and
the control unit displays warning information on the display unit, when the measurement value of the deposition amount is equal to or more than the deposition amount target value and the current value of the coagulant injection rate in the coagulation treatment is more than the upper limit of the coagulant.

15. The monitoring control device according to claim 13, wherein
the storage unit previously stores an upper limit of the coagulant and a pH upper limit target value of the water to be treated in the coagulation treatment; and
the control unit sets the pH upper limit target value as a pH value of the water to be treated in the coagulation treatment, when the measurement value of the deposition amount is equal to or more than the deposition amount target value and the current value of the coagulant injection rate in the coagulation treatment is more than an upper limit of the coagulant.

16. The monitoring control device according to claim 14, wherein
the storage unit previously stores a correlation relation of a water temperature of the supernatant water after separating the oil water in the deposition tank and the deposition amount of the soluble components dissolved in the supernatant water; and
the control unit controls the water temperature of the supernatant water in the deposition tank, on the basis of the correlation relation of the water temperature and the deposition amount.

17. The monitoring control device according to claim 15, wherein
the storage unit previously stores a correlation relation of a water temperature of the supernatant water after separating the oil water in the deposition tank and the deposition amount of the soluble components dissolved in the supernatant water; and
the control unit controls the water temperature of the supernatant water in the deposition tank, on the basis of the correlation relation of the water temperature and the deposition amount.

18. A water treatment method for injecting a coagulant into water to be treated including oil components and supplying supernatant water after coagulation treatment for a treatment process of a rear step, the water treatment method comprising the steps of:
a step for introducing a part of the supernatant water after the coagulation treatment and separating the oil components from the supernatant water;
a step for depositing soluble components dissolved in the supernatant water after separating the oil water; and
a step for calculating an injection rate of the coagulant to be injected into the water to be treated including the oil components, on the basis of at least a deposition amount.

19. The water treatment method according to claim 18, wherein
in the step for calculating of the injection rate of the coagulant, the injection rate of the coagulant to be injected into the water to be treated is calculated on the basis of a measurement value of the deposition amount and a previously set deposition amount target value of the soluble components of the supernatant water.

20. The water treatment method according to claim 19, wherein
in the step for calculating of the injection rate of the coagulant, the injection rate of the coagulant to be injected into the water to be treated is calculated on the basis of a correlation relation of a difference of the deposition amount target value and the measurement value of the deposition amount and an increasing amount of the injection rate of the coagulant injected in the coagulation treatment, previously stored in a storage unit, and a current value of the coagulant injection rate in the coagulation treatment.

21. The water treatment method according to claim 20, further comprising:
a step for adjusting pH by setting a pH lower limit target value of the water to be treated in the coagulation treatment, previously stored in the storage unit, as a pH value of the water to be treated in the coagulation treatment, when the measurement value of the deposition amount is less than the deposition amount target value.

22. The water treatment method according to claim 21, wherein
in the treatment process of the rear step, the supernatant water after the coagulation treatment is injected into an oil layer.
